(19) United States
(12) Patent Application Publication
(10) Pub. No.: US 2004/0218736 A1
(43) Pub. Date: Nov. 4, 2004

(54) Multimedia messaging service provider application programming interface

(76) Inventors: Ching-Ho Fang, Taipei (TW); Meng Ying Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/820,728

(22) Filed: Apr. 9, 2004

(30) Foreign Application Priority Data
Apr. 11, 2003 (TW) 092108441

(51) Int. Cl. H04M 11/00; H04L 12/28; H04M 1/64; H04L 12/56

(52) U.S. Cl. 379/88.13; 379/88.17

(57) ABSTRACT

A multimedia messaging service provider application programming interface comprising a service provider registers with a common service provider server; multiple CPE's (customer premises equipment) register with the common service provider; the service provider server transmits at least one multimedia message and the related info for the multiple CPE's to the common service provider; the common service provider decides whether the multiple CPE's whose info was transmitted by the service provider server are registered; and then the common service provider notifies an MMS Server to send at least one MMS through a common network to the multiple CPE's. One MMS can be sent to multiple CPE's, so that the complexity of service provider servers is reduced and the flexibility of service and server design is increased for service providers.

### BACKGROUND OF THE INVENTION

1. Field of the Invention

The present invention relates to an application programming interface. More specifically, the present invention discloses an application programming interface (API) for a multimedia messaging service provider that provides multimedia messaging services to a plurality of customer premises equipment (CPE's) in order to increase the flexibility of designing services.

2. Description of the Prior Art

Multimedia messaging services can transmit messages with multimedia contents including color pictures, animations, and audio (includes mono tone ring tones, musical instrument digital interface (MIDI) ring tones, audio clips, or even a recording, depending on the mobile phone's support). If the bandwidth allows, it can even transmit movie clips. However, traditional short messaging service (SMS) can only transmit a few words of text and very basic graphics. MMS stands for Multimedia Messaging Service. Continuing the traditional SMS (Short Messaging Service), MMS is not really considered high tech, but according to the 3G developments standard, MMS can transmit mobile messages such as images, audio, and text.

There are a wide variety of applications of MMS. It not only shortens the distance between people, but also enriched their lifestyles. Following are some examples of applications in daily lives. With MMS, a user is able to send photos taken by a digital camera with their friends as a multimedia message to other friends. A user can send one photo to their own mobile phone as screen or desktop wallpaper; to relive the memory with their friends.

No longer does the valuable commuting time to work every morning, need to be wasted. A user can subscribe to a service such as a phrase of the day to improve their language ability. Using MMS to transmit a phrase of the day can not only display multiple languages and phonetics, but can also audibly play the pronunciation. A user can also replay the messages for repeated practicing, as well as saving the MMS files in their mobile phone to study in their free time.

For the people who want to grab financial information at anytime, MMS is a great tool. You can subscribe to a service providing colored diagrams of the stock market, and also designate the time the messages are to be transmitted to your mobile phone. The messages are no longer the conventional simple graphics and diagrams. Therefore, MMS is a winner for smart investors.

If you like collecting cartoon animations, then MMS won't let you down, since the powerful functions of MMS can transmit and play color animations. Therefore, you can connect to websites providing MMS color animations and download your favourite cartoon characters via MMS to your mobile phone to be used as screensavers that always accompany you.

However, it doesn't matter if you are using traditional SMS or MMS, messages can only be transmitted from one mobile phone to another. This is not convenient. Especially for companies that provide services, which need to transmit a large amount of adverts to a vast number of mobile phone users. It is not only slow but also complex since the mobile phone numbers need to be input one by one into the mobile phone. This no longer satisfies the needs of the information age we live in, nor does it achieve direct marketing purposes.

Therefore, there is need for a method of providing service providers with an improved means of multimedia messaging transmission, which overcomes the disadvantage of being able to send only one message to one mobile phone.

### SUMMARY OF THE INVENTION

To achieve these and other advantages and in order to overcome the disadvantages of the conventional method in accordance with the purpose of the invention as embodied and broadly described herein, the present invention provides an application programming interface (API) for a multimedia messaging service provider that provides multimedia messaging services to a plurality of customer premises equipment (CPE's) in order to increase the flexibility of designing services and server systems.

An object of the present invention is to provide a multimedia messaging service provider application programming interface for transmitting multimedia messages by using a common service platform server and a service provider server. The service provider server provides a multimedia message, and then an MMS service server sends the multimedia message to multiple CPE's at one time. This reduces the complexity and increases the flexibility of design for service providers.

Another object of the present invention is that through the establishment of a common service platform server, a high level of security is controlled. The service provider server and the CPE's have to register at the common service platform server; so that the common service platform server can control the origins and destinations as well as the quantity of messages.

Another object of the present invention is to provide a method for transmitting multimedia messages by service providers. After establishing a common service platform server and a service provider server, the common service platform server is able to provide standard interfaces, such as hypertext transfer protocol (HTTP) and enterprise java bean (EJB), as well as using extended mark up language (XML) as parameters for the transmission standard for the service provider server to call upon. In doing so, the limitation of different language platforms can be eliminated. Therefore, no matter what kind of system is used for processing or what language is used to write the program, the common service platform server and service provider server are capable of transmitting the messages.

Another object of the present invention is to provide a multimedia messaging service provider application programming interface for transmitting multimedia messages by establishing a common service platform server; so that the CPE can select the options or items that the service provider server provides on the common service platform server, or the CPE can choose the kind of multimedia message on the service provider server as well as set the delivery time to receive the multimedia message. In doing so, the message is sent according to the time set by the CPE, so that the time to receive the message is flexible and unnecessary multimedia messages such as “junk mail” or spam can be avoid.

The present invention comprises a common service platform server, a service provider server and a multimedia service server. The multimedia service providers must establish a service provider server and register with the common service platform server. CPE's must also register with the common service platform server, in order to control the security. In doing so, the common service platform server can control the service provider server where the multimedia message originated and the CPE where the multimedia message is destined. The service provider server can choose multiple CPE's on the common service platform server, in order to achieve the purpose of being able to transmit messages to multiple CPE's.

The Invention uses HTTP and EJB as interfaces to call upon the service servers of the service providers as well as using XML as parameters for transmission standards, in order to breakthrough the barrier of different platforms and languages. Irregardless of what kind of processing system the service provider utilizes or what kind of language is used for development, the multimedia messages can be called upon by the interfaces, HTTP and EJB, and XML.

A user has control of their privacy by being able to select or block certain senders, service providers, or messages.

Additionally, billing and payment are made more efficient and effective. After the user receives the message, a delivery report or reply is sent back from the user to the multimedia API or common service platform. After this, the service provider and the user are billed.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart illustrating a method of transmitting multimedia messages according to an embodiment of the present invention;

FIG. 2 is a diagram illustrating a method of CPE registration according to an embodiment of the present invention; and

FIG. 3 is a diagram illustrating a multimedia messaging service provider application programming interface according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention solves the problem with traditional multimedia messaging whereby a message can only be transmitted to one mobile phone at a time. The invention also provides a service provide server capable of transmitting multiple messages to multiple CPE's. This not only simplifies the design complexity for service providers, but also increased the flexibility of the design.

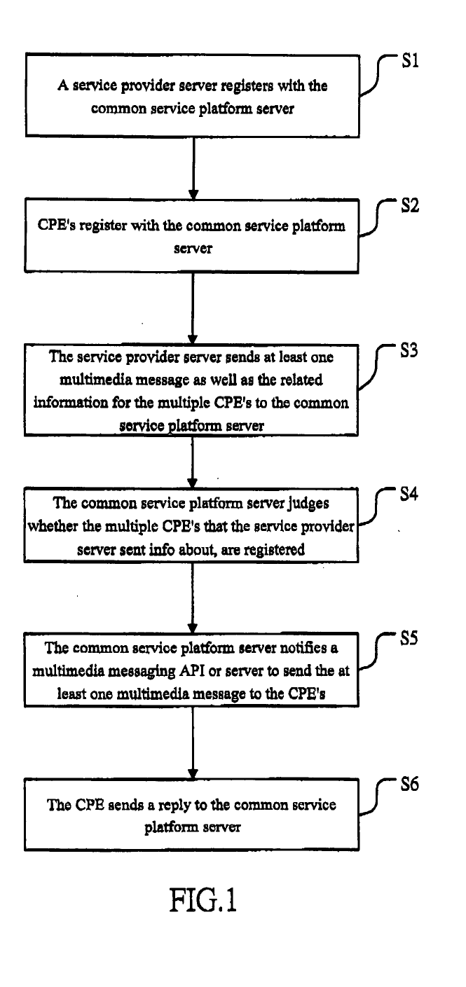

Refer to FIG. 1, which is a flowchart illustrating a method of transmitting multimedia messages according to an embodiment of the present invention.

In step one S1, a service provider server registers with the common service platform server.

In step two S2, multiple CPE's register with the common service platform server. In step three S3, the service provider server sends at least one multimedia message as well as the related information for the multiple CPE's to the common service platform server.

In step four S4, the common service platform server judges whether the multiple CPE's that the service provider server sent info about, are registered.

In step five S5, the common service platform server notifies a multimedia messaging API or server to send the at least one multimedia message to the multiple CPE's via the Web or network.

In step one S1, the service provider server and the common service platform server can be the same server or different servers. The common service platform server provides one password to the service provider server, and at least one or two usernames. The common service platform server uses HTTP and EJB as well as XML as interfaces and language. Therefore, no matter what kind of language is used as a platform, messages can be transmitted and communicated. The service provider server can use a public telecom network, a limited telecom network, a local are network, a wide area network, a radio network, a satellite network, a cable network, a computer network or a cable TV network to transmit messages to the common service platform server.

In step S2, the common service platform server provides at least one username and one password to the CPE. The CPE can use an information network to connect to the common service platform server, in order to register. The information network can be an internet network, or the CPE can use a telecom network to connect to the common service platform server to register. The telecom network can also be a public telecom network, a limited telecom network, a radio network, a satellite network, an optical cable network, a computer network or a cable TV network. The CPE can use an information network to connect to the common service platform server, in order to select the items or types of multimedia messages provided by the common service platform server. The information network can be a public telecom network, a limited telecom network, a local area network, a wide area network, a radio network, a satellite network, an optical cable network, a computer network or a cable TV network.

In step three S3, the CPE's related information that the service provider server sends to the common service platform server comprises a username, a password, a telephone number or any other type of information capable of distinguishing or identifying the CPE.

In step five S5, the communication network can be a public telecom network, a limited telecom network, a radio network, a satellite network, a cable network, a computer network or a cable TV network to connect to the CPE and transmit multimedia messages.

Refer again to FIG. 1. After the CPE has received the multimedia message, in step six S6, the CPE sends a reply to the common service platform server.

The CPE can choose to delete the registration data on the common service platform server, in order to refuse the multimedia message that the service provider server provided. The CPE can also choose the content from the service provider server at the common service provider, in order to avoid receiving unwanted multimedia messages. The CPE can also select the service provider server on the common service platform server, in order to avoid receiving multimedia messages from unwanted service providers. The CPE can also select the delivery time to receive the multimedia message on the Common Service Provider.

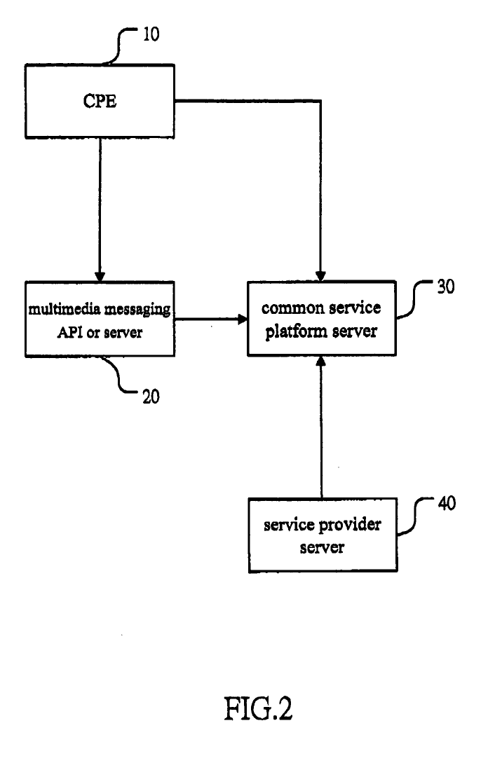

Refer to FIG. 2, which is a diagram illustrating a method of CPE registration according to an embodiment of the present invention.

As shown in FIG. 2, the CPE is referred to as a mobile phone. The issue of security control of the invention is that the CPE and the service provider server have to register with the common service platform server first, so that which multimedia messages are sent by which service provider servers can be controlled, as well as controlling which CPE's receive the messages.

The CPE sends a reply to the common service platform server after receiving the multimedia message. In doing so, the common service platform server is able to charge the CPE as well as the service provider for the multimedia messaging service. The common service platform server acts as an intermediary.

Therefore, the CPE 10 must register with the common service platform server 30. There are two ways to register. One way is by using a mobile phone to connect to a multimedia messaging API or server 20, and then registering with the common service platform server 30; and the other way is to use the Internet to connect directly to the common service platform server 30 to register, skipping the step of registering with the multimedia messaging API or server 20 first. The service provider server 40 also needs to register with the common service platform server 30. The service provider server 40 can also connect to the common service provider 30 via the Internet.

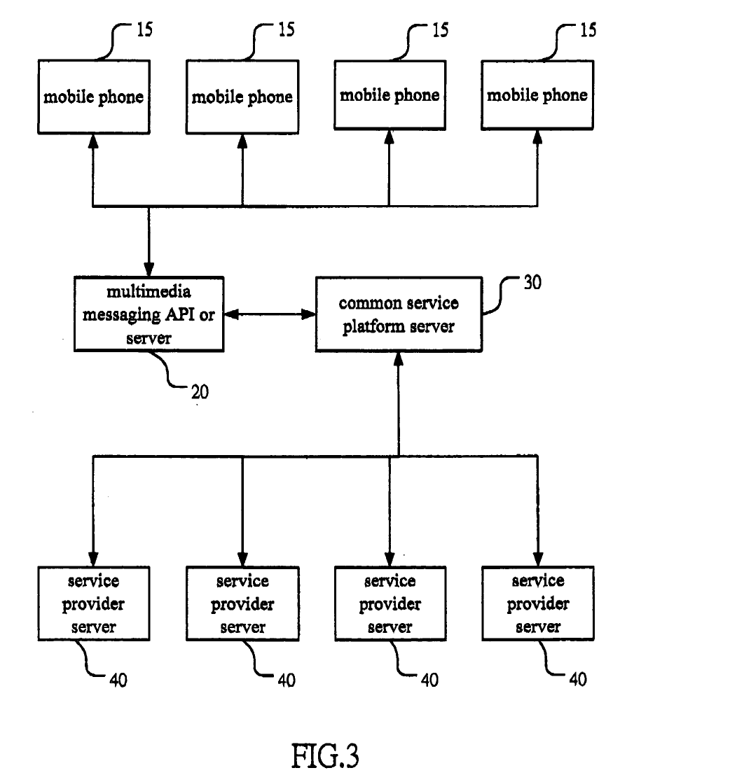

Refer to FIG. 3, which is a diagram illustrating a multimedia messaging service provider application programming interface according to an embodiment of the present invention.

As shown in the diagram, after the mobile phone of the CPE 10 and the service provider server 40 have registered with the common service platform server 30, the service provider server 40 sends at least one multimedia message via the Internet to the common service platform server 30. In addition, the service provider server 40 also sends related info regarding the CPE such as, mobile phone number, username, ID No., etc. According to the CPE's related info, the common service platform server 30 recognizes the mobile phone number where the multimedia message is destined. The common service platform server 30 sends the multimedia message to multiple mobile phones 15 via the multimedia messaging API or server 20.

Therefore, the invention provides tight security control since both the service provider server and the CPE register with the common service platform server. Also, since the originating service provider server that the multimedia message is from and how many CPE's receivers there are is recorded, the billing and payment system is also controlled. After the CPE has received the multimedia message, the mobile phone sends a reply to the common service platform server. The common service platform server acts as an intermediary, and charges the service providers of the service provider servers. By applying the invention, service provider servers can send multimedia message to many CPE's. This overcomes the disadvantage of the traditional method of being only able to send the message to one CPE. In doing so, the flexibility of design is increased for the service providers and the marketing potential of MMS is dramatically expanded.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for broadcast transmitting multimedia messages, comprising:
a service provider registers with a common service platform;
a plurality of customer premises equipment (CPE's) register with the common service platform;
the service provider sends at least one multimedia message as well as related information regarding the CPE's that are to receive the at least one multimedia message to the common service platform;
the common service platform determines whether the CPE's designated by the service provider are registered; and
the common service platform sends the at least one message to the plurality of CPE's via a multimedia messaging server.

2. The method of claim 1, whereby the service provider and the common service platform are a same server.

3. The method of claim 1, whereby the common service platform provides at least one password or one username to the service provider.

4. The method of claim 1, whereby the common service platform provides at least one password or username to each CPE.

5. The method of claim 1, whereby the multimedia message comprises an image, an animation, an audio clip, or text or a combination of the above.

6. The method of claim 1, whereby the common service platform utilizes hypertext transfer protocol (HTTP), enterprise java beans (EJB), or extended markup language (XML) for communicating with the service provider.

7. The method of claim 1, whereby the related information regarding the CPE's that are to receive the at least one multimedia message comprises usernames of the CPE's.

8. The method of claim 1, whereby the related information regarding the CPE's that are to receive the at least one multimedia message comprises usernames and passwords or mobile phone numbers of the CPE's.

9. The method of claim 1, whereby the service provider uses a public telecom network, a limited telecom network, a local area network, a wide area network, a radio network, a satellite network, an optical cable network, a computer network or a cable TV network to transmit multimedia messages to the common service platform.

10. The method of claim 1, whereby the common service platform uses a public telecom network, a limited telecom network, a radio network, a satellite network, an optical cable network, a computer network or a cable TV network to send the multimedia messages to the CPEs.

11. The method of claim 1, whereby after the CPE has received the multimedia message, the CPE sends a reply back to the common service platform.

12. The method of claim 1, whereby the CPE can delete registration data in order to refuse multimedia message from the service provider.

13. The method of claim 1, whereby the CPE can select content on the common service platform to prevent receiving unwanted multimedia messages.

14. The method of claim 1, whereby the CPE can select the service provider on the common service platform to prevent receiving multimedia messages from unwanted service providers.

15. The method of claim 1, whereby the CPE uses information network to connect to the common service platform in order to register or to select content of the multimedia messages that the service provider provides.

16. The method of claim 15, whereby the information network comprises the Internet.

17. The method of claim 15, whereby the information network is a public telecom network, a limited telecom network, a radio network, a satellite network, an optical cable or fiber optic network, or a cable TV network.

18. The method of claim 1, whereby the CPE uses a telephone to connect to the common service platform in order to register or to select content of the multimedia messages that the service provider provides.

19. The method of claim 1, whereby the CPE can set a time of delivery for receiving the multimedia message on the common service platform.
